(19) United States
(12) Patent Application Publication
(10) Pub. No.: US 2013/0067724 A1
(43) Pub. Date: Mar. 21, 2013

(54) Method of positioning metal plate in preparation for welding

(71) Applicant: James Foley, Red Deer County (CA)

(72) Inventor: James Foley, Red Deer County (CA)

(21) Appl. No.: 13/699,759

(22) PCT Filed: May 28, 2010
(86) PCT No.: PCT/CA2010/000819

§ 371 Date: Nov. 26, 2012

(51) Int. Cl. B23Q 7/00

(52) U.S. Cl. 29/559

(57) ABSTRACT

A method of positioning metal plate in preparation for welding. A first metal plate is provided with at least one integrally formed protruding ear positioned along a peripheral edge of the first metal plate. Each ear has a retainer receiving opening. A second metal plate is provided with at least one ear receiving opening extending through the second metal plate from a first face to a second face. The ear of the first metal plate is inserted through the ear receiving opening of the second metal plate. A pressure exerting retainer is then inserted into the retainer receiving opening of the ear to prevent the ear from being withdrawn from the ear receiving opening and to draw the first metal plate and the second metal plate together in preparation for welding.

### FIELD

There is described a method of positioning metal plate in preparation for welding. This method will be described in relation to the fabrication of dozer blades, but can be used for any type of metal plate fabrication where alignment is required prior to welding.

### BACKGROUND

When building an assembly out of metal plate, parts of the assembly are fit together prior to welding. The parts are positioned, measured and squared using tape measures, rules, squares, clamps, jigs, and callipers. The parts are then tack welded together. Once tack welded together, the assembly is re-measured to ensure accuracy prior to welding.

U.S. Pat. No. 1,309,067 (Heltzel) is an example of a tool used to hold metal plate in preparation of welding. U.S. Pat. No. 5,878,940 (Rosenbalm) and U.S. Pat. No. 6,135,666 (Kelly et al) are examples of alternative methods of plate positioning. There will hereinafter be described a method of positioning metal plate in preparation for welding.

### SUMMARY

There is provided a method of positioning metal plate in preparation for welding: A first metal plate is provided with at least one integrally formed protruding ear positioned along a peripheral edge of the first metal plate. Each ear has a retainer receiving opening. A second metal plate is provided with at least one ear receiving opening extending through the second metal plate from a first face to a second face. The ear of the first metal plate is inserted through the ear receiving opening of the second metal plate. A pressure exerting retainer is then inserted into the retainer receiving opening of the ear to prevent the ear from being withdrawn from the ear receiving opening and to draw the first metal plate and the second metal plate together in preparation for welding.

With the above described method, the insertion of retainers into the retainer receiving openings in the ears of the metal plate components serves to clamp and align the metal plate assembly in preparation for welding. This eliminates the need for jigging systems, clamping tools and measuring equipment and saves significant time. Notwithstanding its comparative simplicity, the method provides accuracy that meets or exceeds that provided by other systems and helps to reduce human error. The end result is stronger higher quality products that are produced in a fraction of the time it formerly required, at greatly reduced cost.

After welding, in most cases the retainer becomes redundant and can be withdrawn from the retainer receiving opening of the ear. Whether further steps are taken to improve the aesthetic appearance of the assembly, will depend upon the application. For many applications, the ears can simply be left in place. For other applications, the ears will be cut off to leave a planar surface. In yet other applications, the ears will first be cut off and then the ear receiving opening welded over. In some applications, the retainer is left in place and welded into the product for engineered strength purposes.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an exploded perspective view of a first metal plate and a second metal plate to be assembled in accordance with the teachings of the present method of positioning metal plate in preparation for welding.

FIG. 2 is a perspective view of the first metal plate and the second metal plate of FIG. 1 with the first metal plate and the second metal plate positioned to form an assembly.

FIG. 3 is a perspective view of the first metal plate and the second metal plate of the assembly of FIG. 2 locked in position with a wedge.

FIG. 4 is a perspective view of the assembly of FIG. 3 after welding, with the protruding ear cut off.

FIG. 5 is an exploded perspective view of a section of a dozer blade assembly.

FIG. 6 is a perspective view of the dozer blade assembly of FIG. 5 with a vertical stiffener reinforcing a blade body.

FIG. 7 is a perspective view of the dozer blade assembly of FIG. 6 with the vertical stiffener locked in place with a wedge.

FIG. 8 is a perspective view of the dozer blade assembly of FIG. 7, with a horizontal stiffener reinforcing the blade body.

FIG. 9 is a perspective view of the dozer blade assembly of FIG. 8 with the horizontal stiffener locked in place with a wedge.

FIG. 10 is an exploded perspective view of an alternative configuration to that illustrated in FIG. 1 with a detachable ear portion.

FIG. 11 is a perspective view of the alternative configuration illustrated in FIG. 10, with the detachable ear portion engaged with a fixed ear portion.

FIG. 12 is a perspective view of the alternative configuration FIG. 11 with the first metal plate, the second metal plate positioned to form an assembly, with the detachable ear portion protruding.

FIG. 13 is a perspective view of the first metal plate and the second metal plate of the assembly of FIG. 12 locked in position with a wedge.

FIG. 14 is a perspective view of the assembly of FIG. 13 with wedge and detachable ear portion removed after welding.

FIG. 15 is an exploded perspective view of a variation of retainer to that illustrated in FIG. 1 with a screw jack retainer.

FIG. 16 is a perspective view of a variation of retainer illustrated in FIG. 15, with the first metal plate and the second metal plate positioned to form an assembly.

FIG. 17 is a perspective view of a variation of retainer illustrated in FIG. 16 with the screw jack retainer inserted into the retainer receiving opening.

FIG. 18 is a perspective view of a variation of retainer illustrated in FIG. 17 locked in position.

FIG. 19 is an exploded perspective view of a variation of retainer to that illustrated in FIG. 1 with a cam lock retainer.

FIG. 20 is a perspective view of a variation of retainer illustrated in FIG. 19, with the first metal plate and the second metal plate positioned to form an assembly.

FIG. 21 is a perspective view of a variation of retainer illustrated in FIG. 20 with the cam retainer inserted into the retainer receiving opening.

FIG. 22 is a perspective view of a variation of retainer illustrated in FIG. 21 locked in position.

FIG. 23 is an exploded perspective view of a variation of retainer to that illustrated in FIG. 1 with a hydraulic jack retainer.

FIG. 24 is a perspective view of a variation of retainer illustrated in FIG. 23 with the first metal plate and the second metal plate positioned to form an assembly.

FIG. 25 is a perspective view of a variation of retainer illustrated in FIG. 24 with the hydraulic retainer inserted into the retainer receiving opening

FIG. 26 is a perspective view of a variation of retainer illustrated in FIG. 25 locked in position.

### DETAILED DESCRIPTION

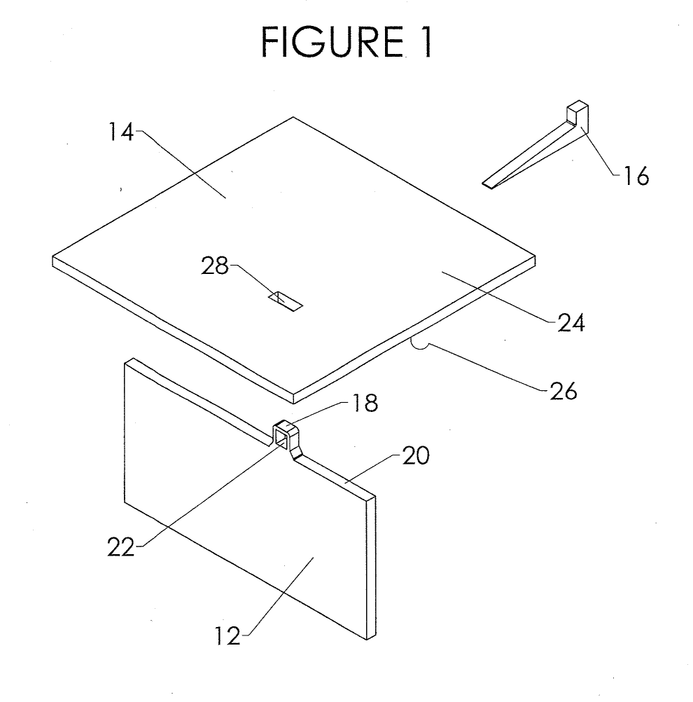

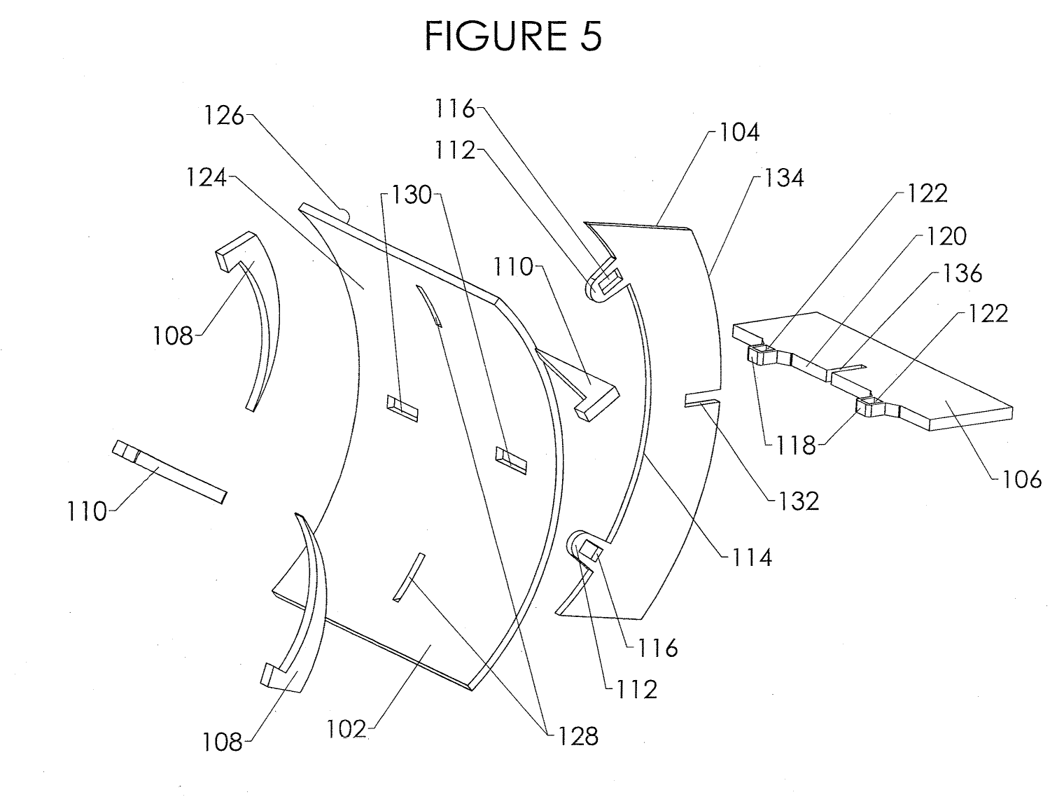

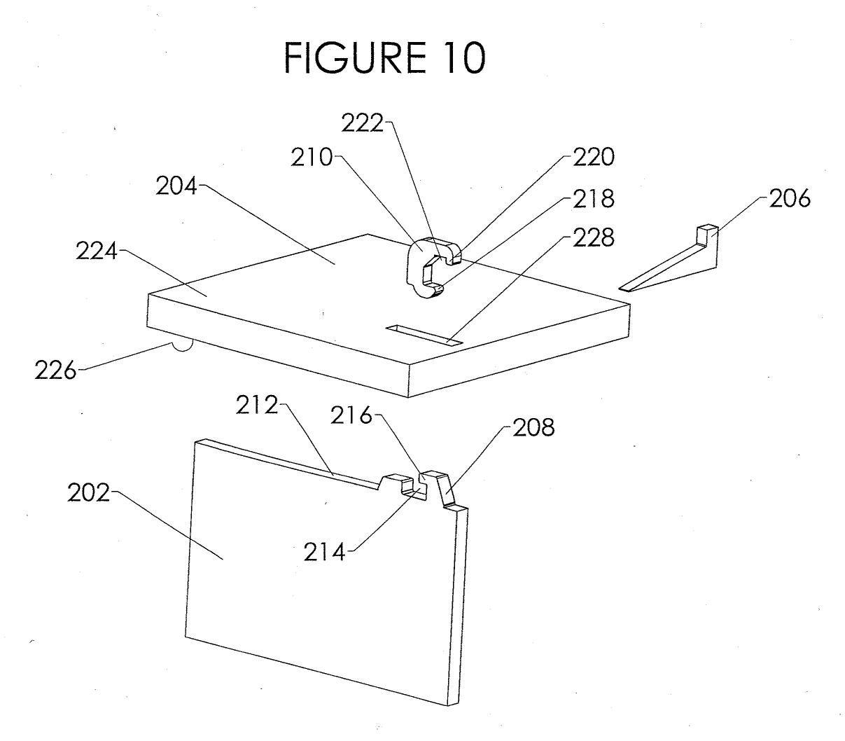

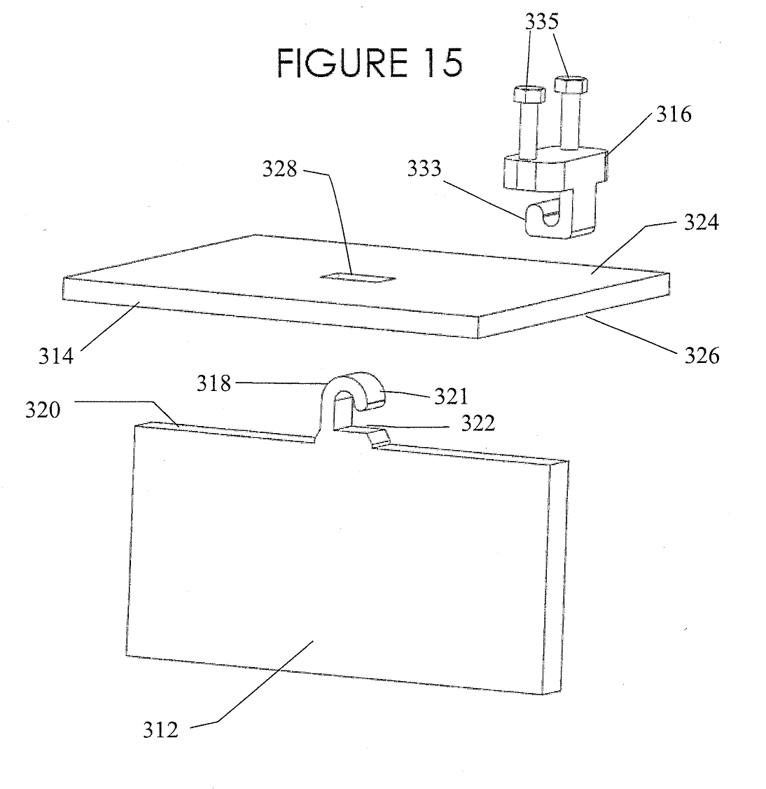

A method of positioning metal plate in preparation for welding will now be described. The basic method will be described with reference to FIG. 1 through FIG. 4. The use of method for the construction of a section of a dozer blade assembly will then be described with reference to FIG. 5 through FIG. 9. An alternative configuration that uses a detachable ear portion will then be described with reference to FIG. 10 through FIG. 14. Retainer variations will then be described with reference to FIG. 15-26.

### Basic Method

Referring to FIG. 1, there are illustrated three components as they would appear prior to assembly: a first metal plate 12, a second metal plate 14 and a pressure exerting retainer 16, shown in this embodiment as a wedge. First metal plate 12 has an integrally formed protruding ear 18 positioned along a peripheral edge 20. Ear 18 has a wedge receiving opening 22. Second metal plate 14 has a first face (top face) 24, a second face (bottom face) 26 and a slotted ear receiving opening 28 which extends from first face 24 through to second face 26.

First metal plate 12 and second metal plate 14 are preferably cut using very tight tolerance cutting equipment such as laser or water jet cutting machines. The type of equipment used to cut is dependent on the tolerance of fabrication needed for the product being built. It will be recognized, however, that it would be possible to fabricate to lesser tolerances using equipment such as high definition plasma or oxy-fuel torch tables. It will also be appreciated that ear 18, retainer receiving opening 22 and ear receiving opening 28 could all be made in configurations other than that which has been chosen for illustration. The configurations chosen for illustrations are intended to represent the best manner of implementing the method that is currently known.

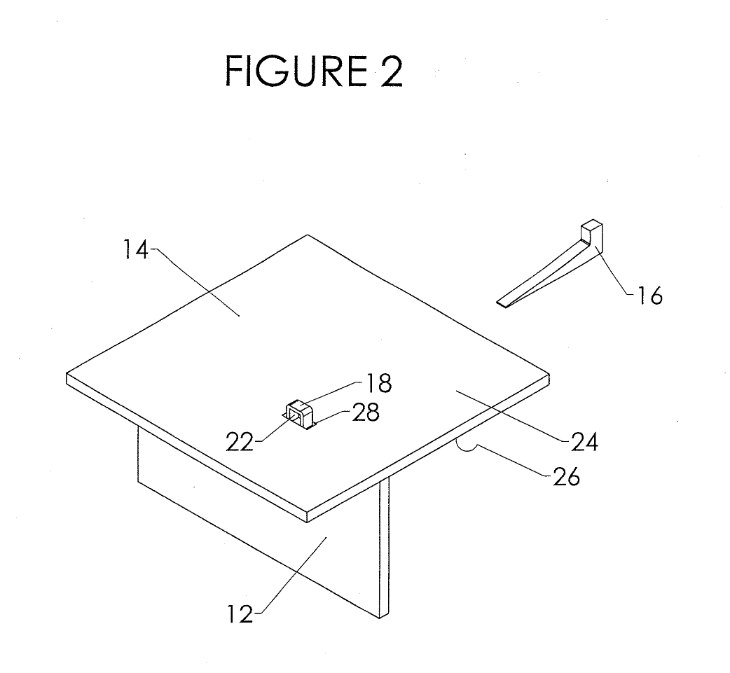

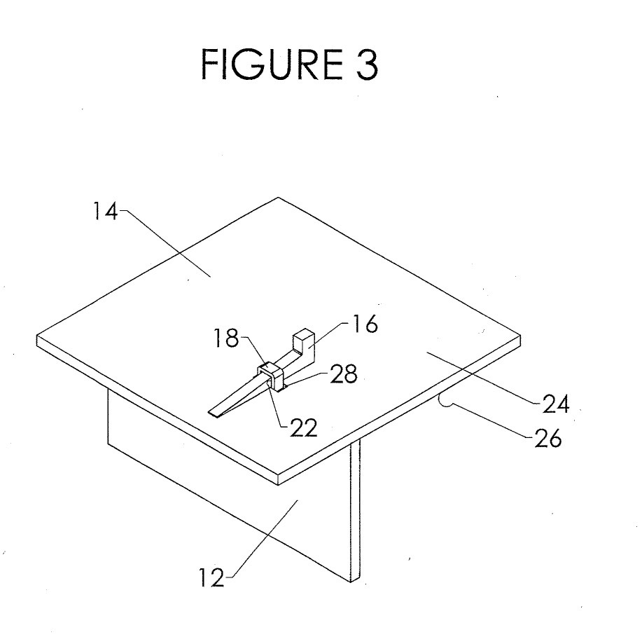

Referring to FIG. 2, ear 18 of first metal plate 12 is inserted through ear receiving opening 28 of second metal plate 14. Referring to FIG. 3, wedge 16 is then inserted into retainer receiving opening 22 of ear 18. This prevents ear 18 from being withdrawn from ear receiving opening 28. More importantly, as wedge 16 is inserted into place, it serves to draw first metal plate 12 and second metal plate 14 together in preparation for welding. If care is taken in planning the assembly and there are close tolerances between the components, assembly of the components results in self positioning which requires little or no measuring.

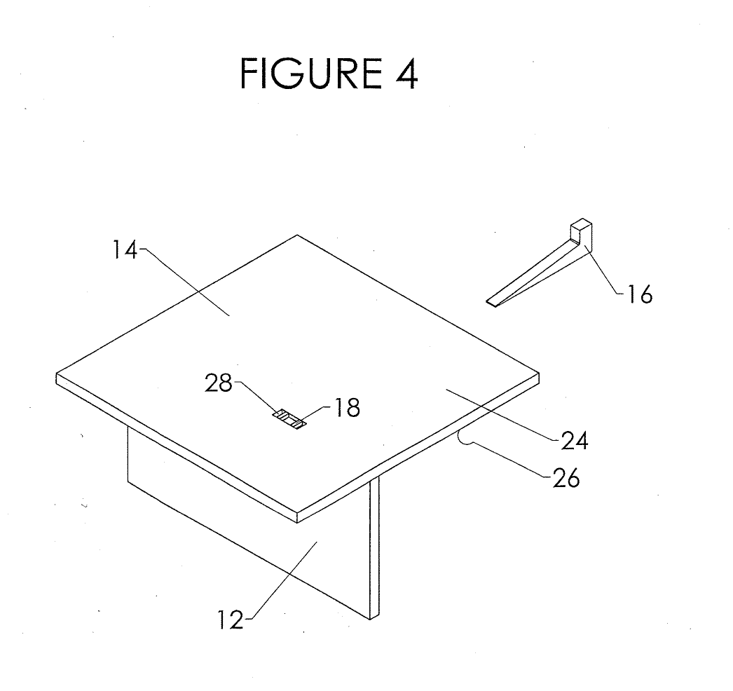

Referring to FIG. 4, once first metal plate 12 and second metal plate 14 are welded together, wedge 16 becomes redundant and can be withdrawn from retainer receiving opening 22 of ear 18. For some assemblies, it will not matter whether wedge 16 is removed or the removal of wedge 16 will complete the assembly. However, where a planar surface is required, a further step will be taken of removing ear 18 (as has been illustrated) after withdrawing wedge 16. This can be done in various ways, such as by grinding. Where a more finished appearance is required, a further step may be taken of welding over ear receiving opening 28 after removing the ear.

### Application of Method To Fabricate A Dozer Blade

Referring to FIG. 5 through 9, there will now be described how the method may be used to manufacture a dozer blade, generally identified by reference numeral 100. It is important to note that only a section of the dozer blade has been chosen of illustration to simplify the illustration and the description which follows. The section of the dozer blade 100 which has been illustrated represents only about 5% of the size of a standard dozer blade. It will be appreciated, however, that the entire dozer blade is being fabricated using these principles. Once understood, it will also be appreciated that the same methodology can be used to fabricate any useful article out of metal plate.

Referring to FIG. 5, there are illustrated components as they would appear prior to assembly: a curved blade body 102 (also known as a blade skin), a vertical stiffener 104 (also known as a vertical frame), a horizontal stiffener 106 (also known as a horizonal frame), curved wedges 108, and straight wedges 110. It will be appreciated that alternative retainers may be used in place of the wedges as described and illustrated. Vertical stiffener 104 has two integrally formed protruding ears 112 positioned along a concave peripheral edge 114. Each of ears 112 have a wedge receiving opening 116. Horizontal stiffener 106 has two integrally foamed protruding ears 118 positioned along a peripheral edge 120. Each of ears 118 have a wedge receiving opening 122. Curved Blade body 102 has a first face (concave face) 124 and a second face (convex face) 126. Vertically oriented ear receiving openings 128 extend from first face 124 through to second face 126. Horizontally oriented ear receiving openings 130 similarly extend from first face 124 through to second face 126.

In order to relate the terminology used with respect to FIG. 1 through 5, with the terminology used with respect to dozer blade 100, both vertical stiffener 104 and horizontal stiffener 106 are playing the same role in the assembly of dozer blade 100 as did first metal plate 12. Curved blade body 102 is playing the same role in the assembly of dozer blade 100 as did second metal plate 14. There has been illustrated two each of ears 112, vertically oriented ear receiving openings 128, ears 118 and horizontally oriented ear receiving openings 130. It will be appreciated that if the entirety of dozer blade 100 were viewed, there would be more than two of each to assist in alignment over the larger surface area. It will also be appreciated that if the entirety of dozer blade 100 were viewed, there would be multiple vertical stiffeners 104, and multiple horizontal stiffeners 106 with both having multiple ears 118.

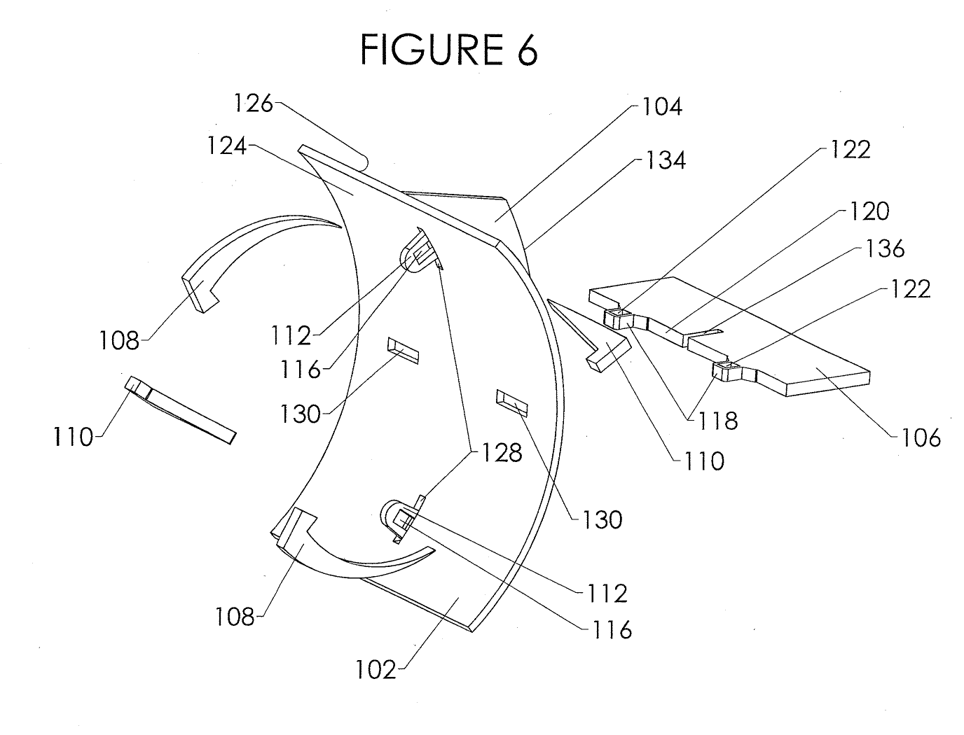

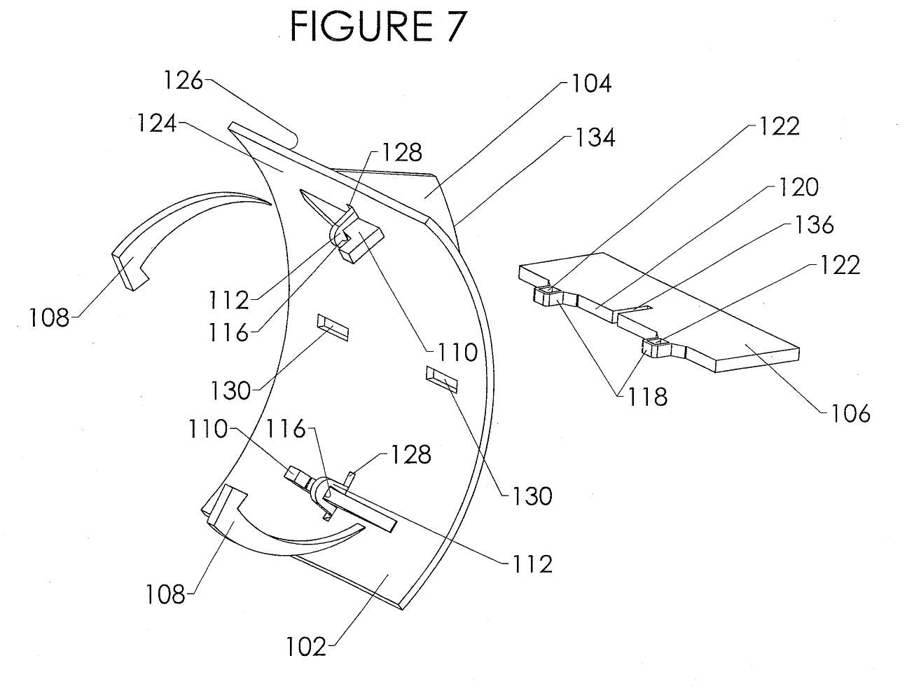

Referring to FIG. 6, ears 112 of vertical stiffener 104 are inserted through vertically oriented ear receiving openings 128 of curved blade body 102. Referring to FIG. 7, straight wedges 110 are then inserted into wedge receiving openings 116 of each ear 112. This prevents ear 112 from being withdrawn from vertically oriented ear receiving opening 128. More importantly, as straight wedges 110 are inserted into place, it serves to draw vertical stiffener 104 and curved blade body 102 together in preparation for welding.

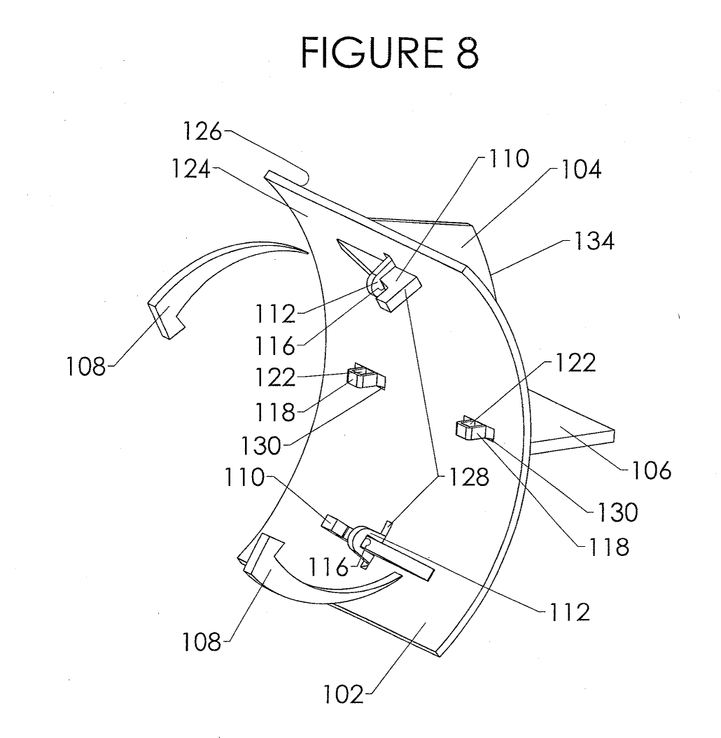

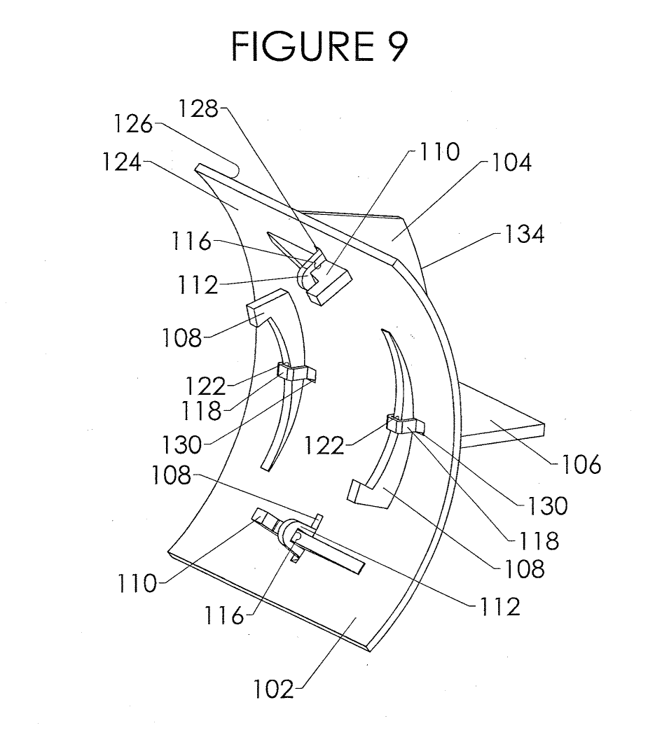

Referring to FIG. 8, ears 118 of horizontal stiffener 106 are inserted through horizontally oriented ear receiving openings 130 of curved blade body 102. Referring to FIG. 9, curved wedges 108 are then inserted into wedge receiving openings 122 of each ear 118. This prevents ear 118 from being withdrawn from horizontally oriented ear receiving opening 130. More importantly, as curved wedges 108 are inserted into place, it serves to draw horizontal stiffener 106 and curved blade body 102 together in preparation for welding. Referring to FIG. 5, vertical stiffener 104 has a slot 132 along its spine 134 to receive horizontal stiffener 106 and horizontal stiffener 106 has a slot 136 along peripheral edge 120 to receive vertical stiffener 104. When horizontal stiffener 106 is engaged in slot 132 and vertical stiffener 104 is engaged in slot 136, it enables horizontal stiffener 106 to straddle vertical stiffener 104 for insertion of ears 118 into horizontally oriented ear receiving openings 130 of curved blade body 102.

### Advantages

The speed in which a product can be built using this method of fabrication in most cases at least doubles compared to commonly practiced methods. The time saving is evident in all areas of business from extensive time that was previously spent on detailed measuring and placement of parts using various jigging and clamping devices, to the inspection and repair after welding due to warping and distortion. Previously setup times of often large pieces of jigging equipment needed to fabricate most plate steel products made it difficult to switch from one product to another in an efficient manner. Now that most jigging systems can be removed from the equations, assembly time of the product is greatly decreased and so is the time to switch between building different types of products. By removing large amounts of jigging and tooling systems a facility can efficiently use its space to increase product lines and production. This simplifying method also greatly decreases fabricator training time. The ease of the process allows apprentice welders and fabricators to fabricate complicated assemblies of product that would usually be given to experienced journeymen. In addition apprentices are able to work with less direct supervision. This method of fabrication that has the ability to create a product from metal plate with constant identical results that gives additional precision in automation. The types of metal plate products that this process is applicable to is endless. The more complicated the product, the more efficient this method of fabrication becomes. Yet another major advantage is the engineered strength created in the product.

### Alternative Embodiments

There will now be described with reference to FIG. 10 through FIG. 14, an alternative embodiment, generally identified by reference numeral 200. Alternative embodiment 200 is very similar to what has been described in relation to FIG. 1. Referring to FIG. 10, there are illustrated components as they would appear prior to assembly: a first metal plate 202, a second metal plate 204 and a retainer 206, shown as a wedge in this embodiment. An ear is provided, as before, however this ear differs from the previously described embodiment in that there is a fixed ear portion 208 and a detachable ear portion 210. Fixed ear portion 208 is integrally formed with first metal plate 202 and protrudes from a peripheral edge 212. Detachable ear portion 210 interlocks with fixed ear portion 208. Fixed ear portion 208 has an opening 214 and an overlying engagement member 216 that engages detachable ear portion 210 when it is inserted into opening 214. Detachable ear portion 210 has a lower engagement member 218 that engages overlying engagement member 216 when lower engagement member 218 is positioned in opening 214. Detachable ear portion 210 also has a hook like member 220 that defines a retainer receiving opening 222. Second metal plate 204 has a first face (top face) 224, a second face (bottom face) 226 and a slotted ear receiving opening 228 which extends from first face 224 through to second face 226.

Referring to FIG. 2, when working in confined spaces, problems were encountered in later going back to remove that portion of ear 18 that protruded above second plate 14. Referring to FIG. 10, to address this problem in alternative embodiment 200, the ear was made in two portions: fixed ear portion 208 and detachable ear portion 210.

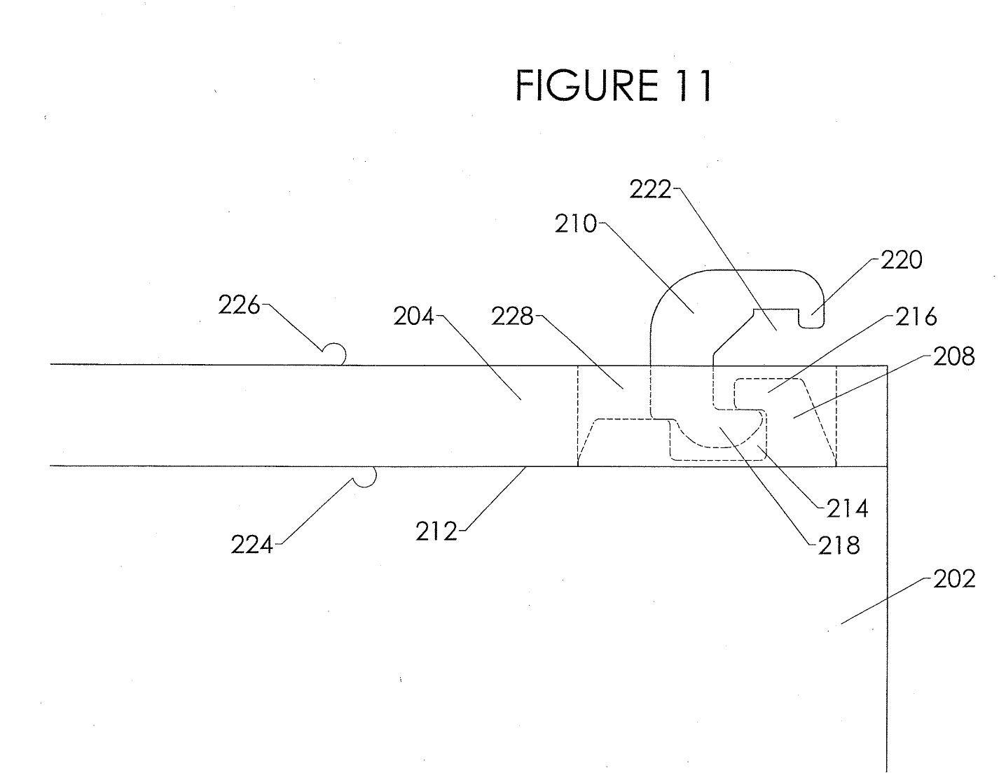

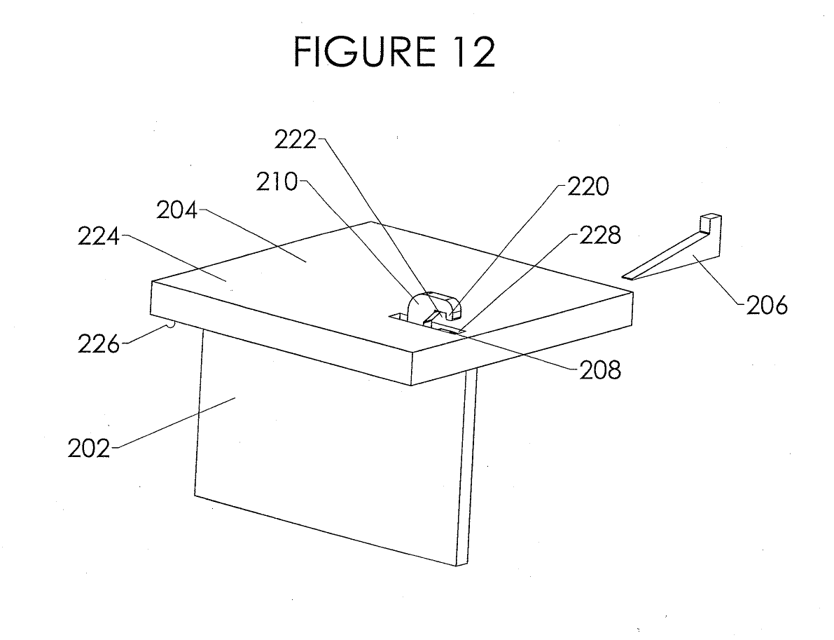

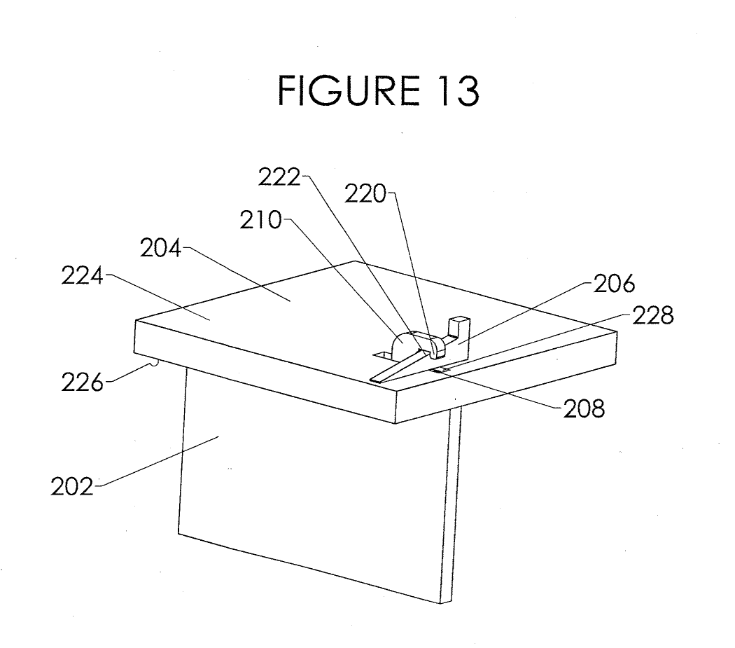

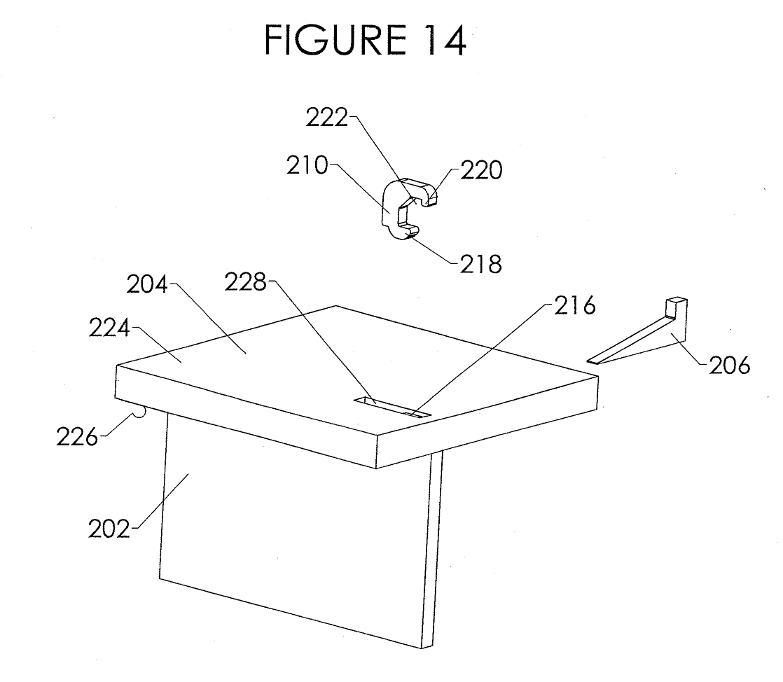

Referring to FIG. 11, fixed ear portion 208 and detachable ear portion 210 are interlocked by inserting lower engagement member 218 of detachable ear portion 210 into opening 214 of fixed ear portion 208 with lower engagement member 218 engaging overlying engagement member 216. Referring to FIG. 12, detachable ear portion 210 of first metal plate 202 is inserted through ear receiving opening 228 of second metal plate 204. Referring to FIG. 13, retainer 206 is then inserted into retainer receiving opening 222 of detachable ear portion 210. This prevents detachable ear portion 210 from being withdrawn from ear receiving opening 228 and, as retainer 206 is inserted into place, it serves to draw first metal plate 202 and second metal plate 204 together in preparation for welding. Referring to FIG. 14, once first metal plate 202 and second metal plate 204 are welded together, retainer 206 becomes redundant and can be withdraw from retainer receiving opening 222 of detachable ear portion 210. Detachable ear portion 210 can then be removed by disengaging lower engagement member 218 from overlying engagement member 216. If space permits, a further step may be taken of welding over ear receiving opening 228 after removing detachable ear portion 210 can be taken to provide a more finished appearance.

### Variations

There will now be described with reference to FIG. 15 through FIG. 26 retainer variations. Apart from a difference in the retainers used the retainer variations are similar to what has been described in relation to FIG. 1 through FIG. 4.

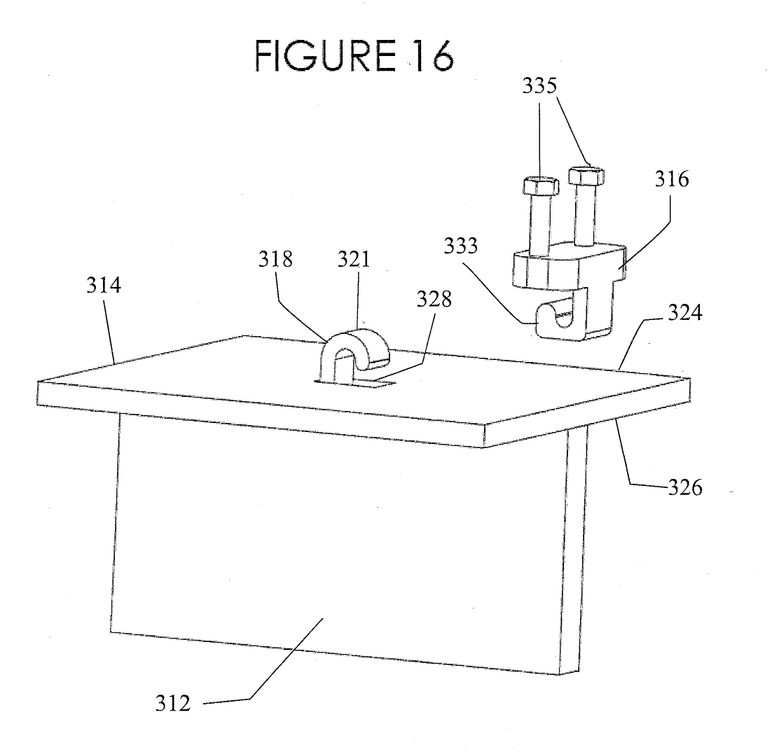

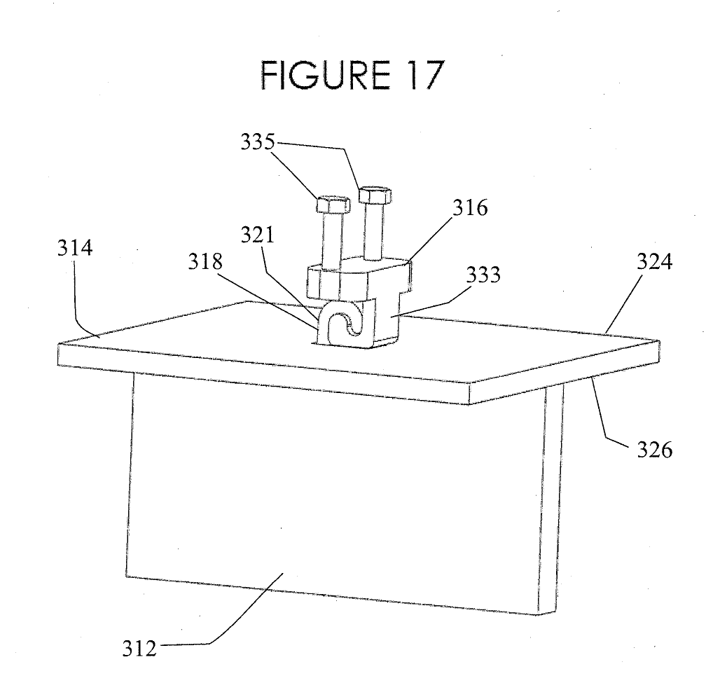

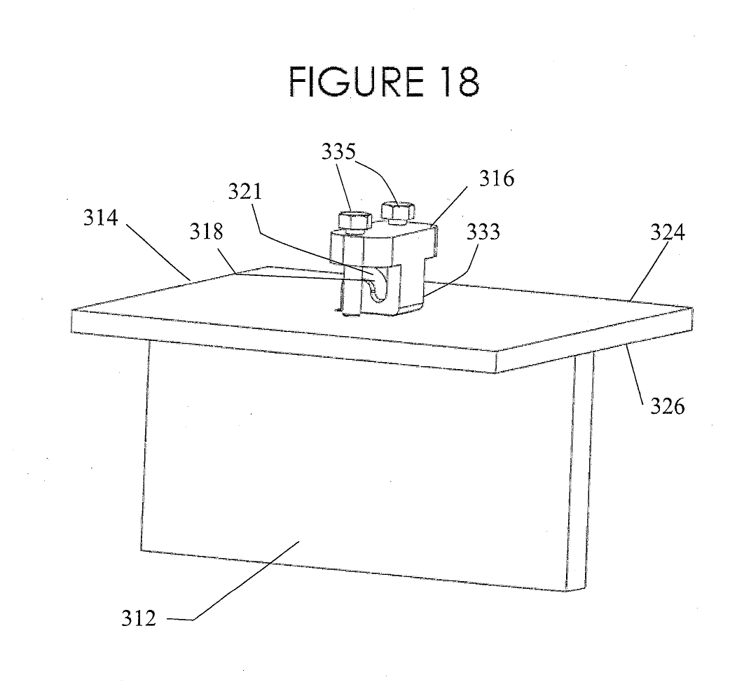

Referring to FIG. 15 through FIG. 18 a variation with screw jack retainer is illustrated. Referring to FIG. 15, there are illustrated three components as they would appear prior to assembly and similar to what is shown in FIG. 1: a first metal plate 312, a second metal plate 314 and a screw jack retainer 316. First metal plate 312 has an integrally formed protruding ear 318 positioned along a peripheral edge 320. Ear 318 has a hook like member 321 that acts as a retainer receiving opening 322. Second metal plate 314 has a first face (top face) 324, a second face (bottom face) 326 and a slotted ear receiving opening 328 which extends from first face 324 through to second face 326 screw jack retainer 316 has a hook like member 333 which corresponds to hook like member 321 of ear 318 and bolts 335 which act to adjust the force exerted upon metal plates 312 and 314. Referring to FIG. 16, ear 318 of first metal plate 312 is inserted through ear receiving opening 328 of second metal plate 314. Referring to FIG. 17, hook like member 333 of screw jack retainer 316 is then inserted into hook like member 321 of ear 318. Referring to FIG. 18, bolts 335 are adjusted to exert a force upon metal plates 312 and 314. This prevents ear 318 from being withdrawn from ear receiving opening 328. This variation is used mainly in thicker plate applications where the position of metal plates 312 and 314 is critical.

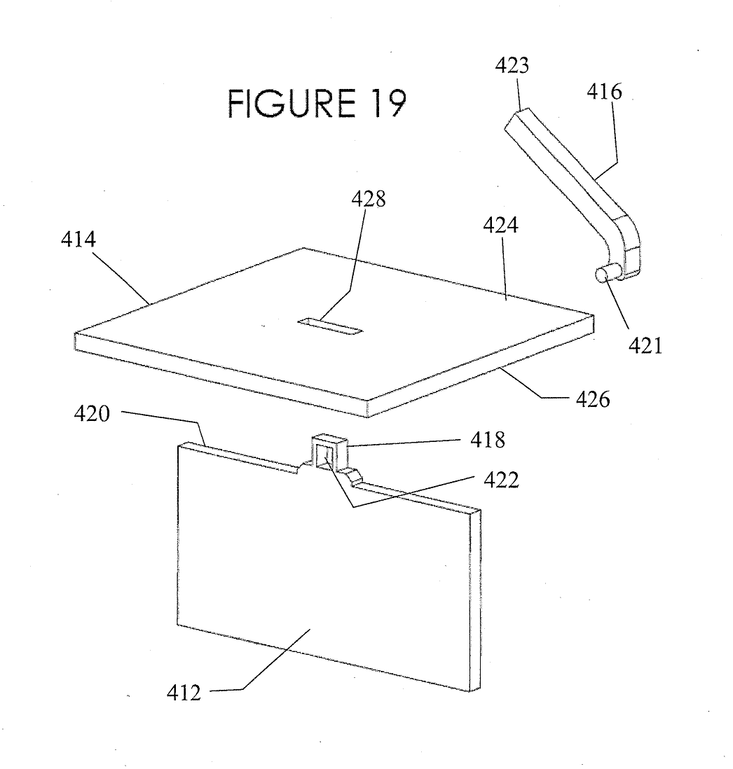

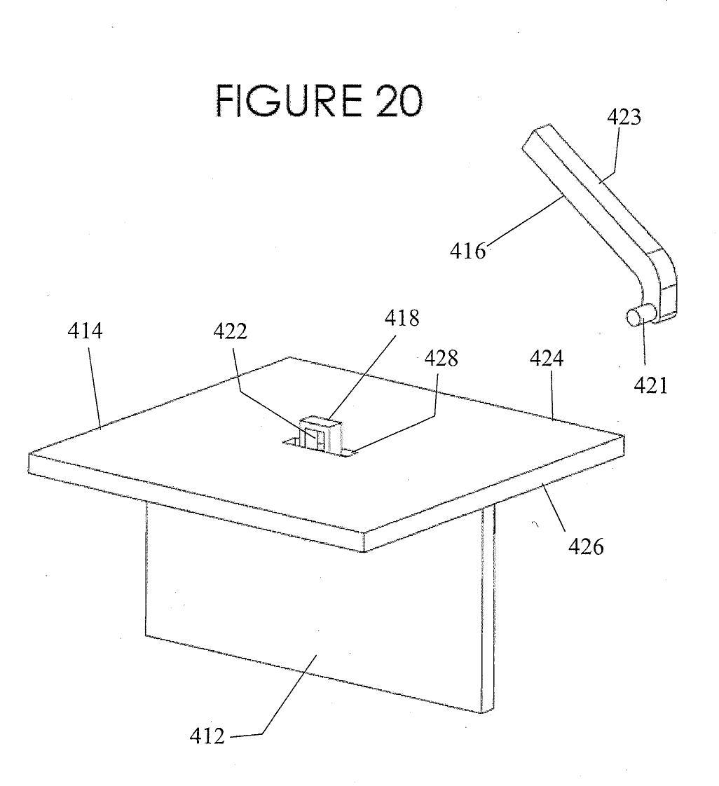

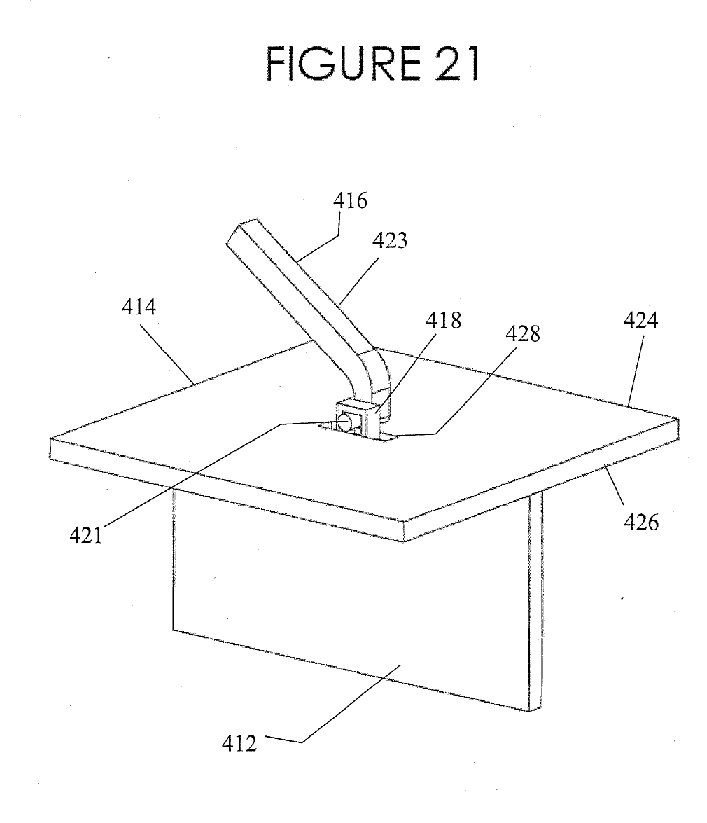

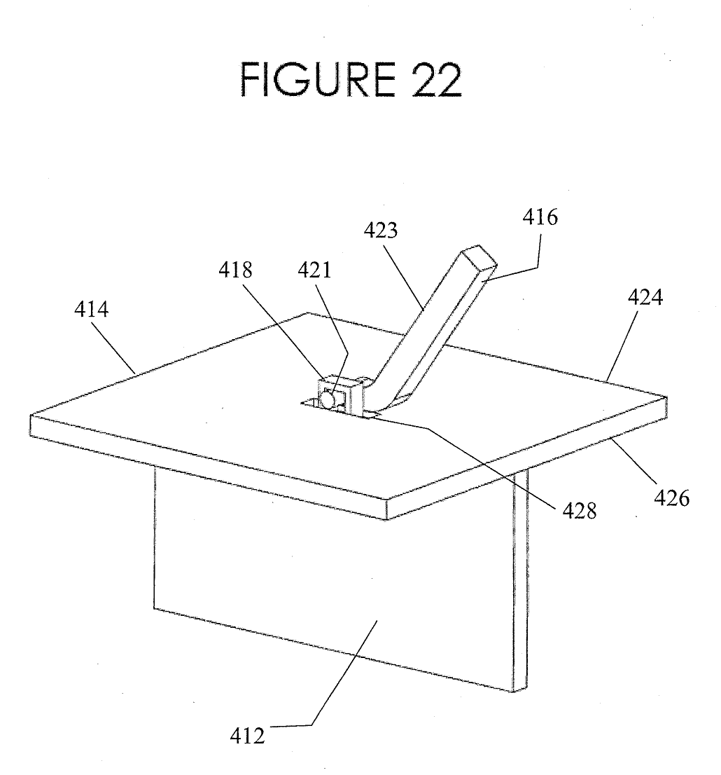

Referring to FIG. 19 through FIG. 22 a variation with a cam lock retainer is illustrated. Referring to FIG. 19, there are illustrated three components as they would appear prior to assembly and similar to what is shown in FIG. 1: a first metal plate 412, a second metal plate 414 and a cam lock retainer 416. First metal plate 412 has an integrally formed protruding ear 418 positioned along a peripheral edge 420. Second metal plate 414 has a first face (top face) 424, a second face (bottom face) 426 and a slotted ear receiving opening 428 which extends from first face 424 through to second face 426. Cam lock retainer 416 has a pin 421 and a handle 423. Referring to FIG. 20, ear 418 of first metal plate 412 is inserted through ear receiving opening 428 of second metal plate 414. Referring to FIG. 21, pin 421 of cam lock retainer 416 is inserted into retainer receiving opening 422. Referring to FIG. 22, handle 423 of cam lock retainer 416 is forced downwards toward first metal plate 412 which pulls the two metal plates 412 and 414 together.

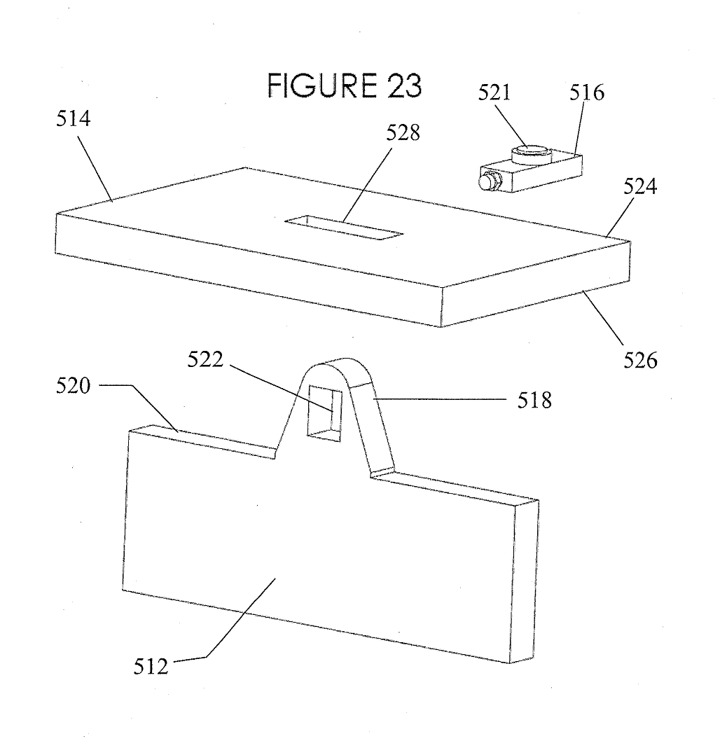

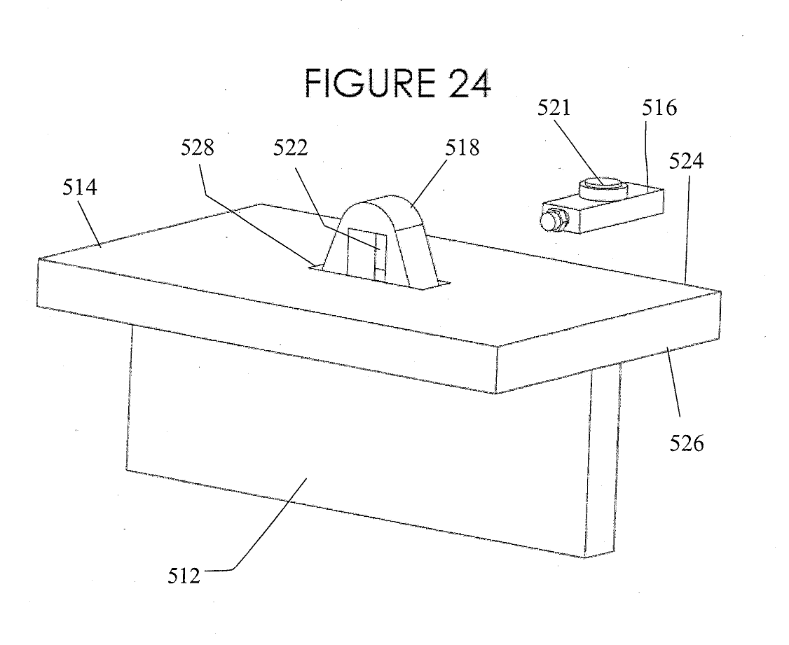

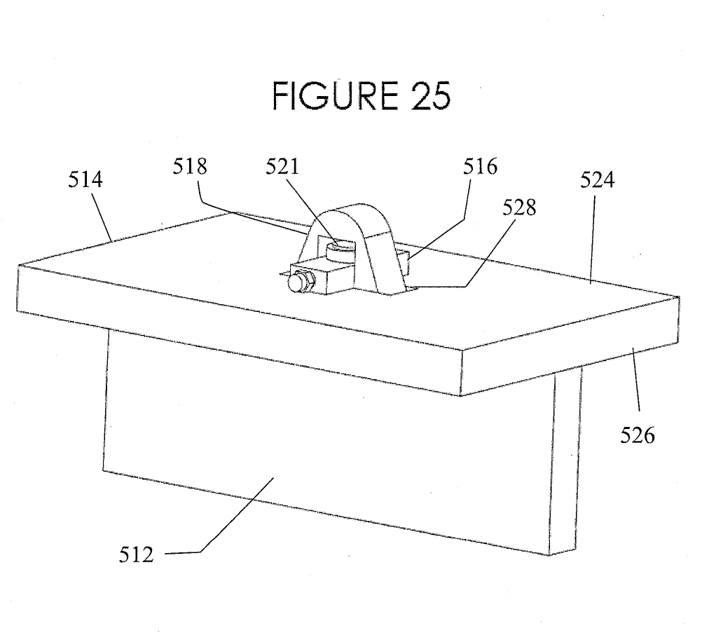

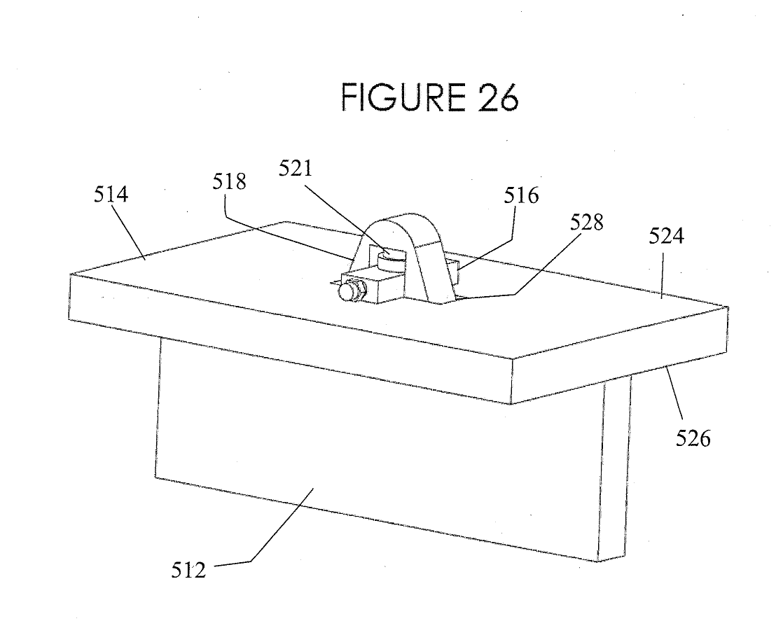

Referring to FIG. 23 through FIG. 26 a variation with a hydraulic retainer is illustrated. Referring to FIG. 23, there are illustrated three components as they would appear prior to assembly and similar to what is shown in FIG. 1: a first metal plate 512, a second metal plate 514 and a hydraulic retainer 516. First metal plate 512 has an integrally formed protruding ear 518 positioned along a peripheral edge 520. Second metal plate 514 has a first face (top face) 524, a second face (bottom face) 526 and a slotted ear receiving opening 528 which extends from first face 524 through to second face 526. Hydraulic retainer 516 has a hydraulic jack 521 vertically movable by hydraulic means. Referring to FIG. 24, ear 518 of first metal plate 512 is inserted through ear receiving opening 528 of second metal plate 514. Referring to FIG. 25, hydraulic retainer 516 is inserted into retainer receiving opening 522 such that hydraulic jack 521 faces upwards and is in a lower position. Referring to FIG. 26, hydraulic jack 521 of hydraulic retainer is extended in an upwards direction to engage retainer receiving opening 522 and pull and lock metal plates 512 and 514 into position. This variation is mainly used to pull very large plates together.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method of positioning metal plate in preparation for welding, comprising:
providing a first metal plate, with at least one integrally formed protruding ear positioned along a peripheral edge of the first metal plate, the ear having a retainer receiving opening;
providing a second metal plate, with at least one ear receiving opening extending through the second metal plate from a first face to a second face;
inserting the ear of the first metal plate through the ear receiving opening of the second metal plate; and
inserting a pressure exerting retainer into the retainer receiving opening of the ear to prevent the ear from being withdrawn from the ear receiving opening and to draw the first metal plate and the second metal plate together in preparation for welding.

2. The method of claim 1, including a step of welding the first metal plate and the second metal plate together and then withdrawing the pressure exerting retainer from the retainer receiving opening of the ear.

3. The method of claim 2, including a step of removing the ear after withdrawing the pressure exerting retainer.

4. The method of claim 3, including a step of welding over the ear receiving opening after removing the ear.

5. The method of claim 1, wherein there is more than one integrally formed protruding ear.

6. The method of claim 1, wherein there is more than one ear receiving opening.

7. The method of claim 1, wherein the ear has a fixed ear portion and a detachable ear portion which engages the fixed ear portion.

8. The method of claim 1, wherein the retainer is a wedge.

9. The method of claim 1, wherein the retainer is a cam lock.

10. The method of claim 1, wherein the retainer is a hydraulic jack.

11. The method of claim 1, wherein the retainer is a screw jack.
